(19) United States
(12) Patent Application Publication
(10) Pub. No.: US 2018/0065218 A1
(43) Pub. Date: Mar. 8, 2018

(54) BLADE REMOVING TOOL FOR ROTARY LAWN MOWERS

(71) Applicant: Daniel Lee White, Clermont, FL (US)

(72) Inventor: Daniel Lee White, Clermont, FL (US)

(21) Appl. No.: 15/256,971

(22) Filed: Sep. 6, 2016

(51) Int. Cl. B23Q 3/00; A01D 75/12

(52) U.S. Cl. CPC B23Q 3/00; B25B 13/04; A01D 75/12

(57) ABSTRACT

A device constructed of a material strong enough to withstand the torque of a typical air wrench or breaker bar used by a lawn mower repair shop or a homeowner. The device must secure two lawn mower blades together in order to bind the blades. The device captures the opposing torque of both blades to cause a restriction in the blades ability to spin freely. To provide economics for manufacturing, one size should fit most blades and the device should require a limited quantity of materials and fabrication.

### BACKGROUND OF THE INVENTION

### Field of the Idea

This invention relates to the removal and installation of lawn mower blades, specifically to produce devices to be placed upon or over lawn mower blades to assist in stopping rotation of said blades so they may be safely removed and/or installed.

For peak efficiency, lawn mower blades should be re-sharpened or replaced regularly. It is difficult at best and even dangerous to remove any blade retaining nut or bolt, especially so if the nut or bolt has been over-tightened or rusted in place. The problem is to lock the blade positively against rotation so the high torque necessary to loosen the blade retaining nut or bolt can be applied with a wrench. Holding the blade with a gloved hand does not guarantee enough leverage to loosen the nut especially because blades are routinely installed with a torque tightness of 60 to 120 foot pounds or more and may tend to tighten even more in use.

The typical device to assist users in this procedure that lawn mower manufacturers and their service technicians recommend is a block of wood wedged between the mower housing and the blade. While some commercial mower manufacturers may suggest an impact wrench to remove blades, blades must be re-installed with a hand torque wrench requiring an ability to jam the blade to prevent movement. Using a wood block may result in injury as the block is typically held in place either by gravity or pressure and tends to fall and allow the blade to rotate. This may result in skinned knuckles, cut hands or fingers, or the complete loss of the same. Further, with a mulching deck (which typically is a complete circular tunnel surrounding the blade) there is no place against which the block of wood can be jammed.

Technicians, while performing this process in factory trained shops, commonly use an air wrench to loosen or tighten the blade retaining bolts with one hand while holding the blade with the other. The primary protection for the hands is a rag over the blade or wearing a glove on the hand that holds the blade. This procedure may result in injury to the technician because it depends on their strength and balance to hold the blade steady while using torque of said air wrench. Often, the retaining bolt is frozen or the technician over tightens said retainer and cannot hold the blade. This injury is likely more severe because of the strength and speed of said air tool.

The problem is further compounded by the ground level location of the blade and it is only limitedly visible and accessible through the discharge chute (not present on mulching mowers) unless the mower is elevated using ramps or jacks, tilted backwardly or on its side, or turned upside down. As a practical matter, a heavy riding mower or commercial mower is generally not elevated on blocks just to remove the blades for sharpening. Instead, the mower deck is elevated as far as it will go, which will give about 5″ of visibility and working space for a person lying or crouching on the ground.

### Brief Description of Prior Art

Searches at the patent library revealed patent application US 2007/0266691 (Elliott et al) for a device that fits around a blade and functions by either jamming the blade against a discharge chute or jamming the blade within the mower deck (for multi-blade movers). The device will not work with a mulching mower or multiple-blade mulching mower deck because the blade housing is circular and provides no surface against which to jam the blade. Further, because of the circular blade housing, it would not be possible to install the device over the blade.

Another patent application US 2001/0035077 (Adams) is for a complicated device which incorporates a wrench with the blade holder. This device requires significant raw material and significant fabrication likely rendering it cost-prohibitive to potential users.

Another patent application US 2001/0035080 (Adams) is for a device which requires the user to use one hand to control the tool and the other hand to utilize the wrench for removal or installation of the blade. Blades typically require substantially more force to remove than to install and riding mower blades can require 120 pounds of torque or more to install. This device, then, requires the user to exert 120 pounds or more force in one direction with the tool while exerting 120 pounds or more force in the opposite direction with the wrench. The operator will not have a free hand to stabilize the wrench on the blade retaining bolt or nut. This device requires significant raw material and significant fabrication likely rendering it cost-prohibitive to potential users.

U.S. Pat. No. 3,134,280 (Guderjan et al.) issued May 26, 1964 is for a device that fits over the blade and requires the user to place the user's hand under the mower deck and into the path of the blade. It would require significant personal strength as there is limited, if any, leverage advantage. This device requires the user to use one hand to control the tool and the other hand to utilize the wrench for removal or installation of the blade.

Blades typically require substantially more force to remove than to install and riding mower blades can require 120 pounds of torque to install. This device, then, requires the user to exert 120 pounds or more force in one direction with the tool while exerting 120 pounds or more force in the opposite direction with the wrench. The operator will also not have a free hand to stabilize the wrench on the blade retaining bolt. This device requires significant raw material and significant fabrication likely rendering it cost-prohibitive to potential users.

U.S. Pat. No. 3,173,234 (Vodinelich) issued Mar. 16, 1965 is for a device that locks the blade by friction and works on thin stamped mower decks without the now typical extra lip at the bottom. It is intended for use on single-blade mower decks so it would not be useful for multiple-blade decks typical of riding and commercial mowers. This device would likely require removing built-up grass and debris from the inside of the mower deck to provide sufficient clamping force. Significant fabrication is required likely rendering it cost-prohibitive to potential users.

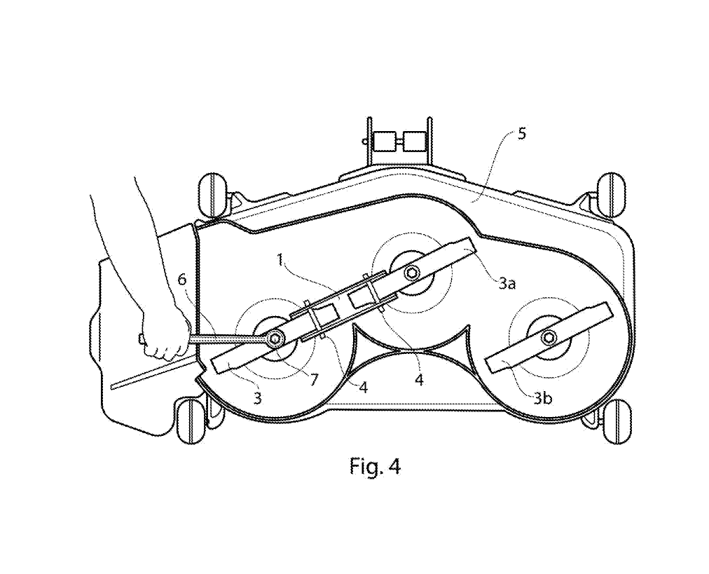

U.S. Pat. No. 4,208,859 (Brockway) issued Jun. 24, 1980 is for a device that locks the blade by friction and works on thin stamped mower decks without the now typical extra lip at the bottom. Further, it would not work on most fabricated metal decks (FIG. 4) (as opposed to stamped decks) which are typically employed by manufacturers of commercial quality mowers. This device would likely require removing built-up grass and debris from the inside of the mower deck prior to use.

U.S. Pat. No. 4,564,991 (Taylor) issued Jan. 21, 1986 is for a special tool which works only if the mower is turned upside down; as a result it can be used only with very light weight lawn mowers. However, it is unsafe to turn any mower upside down without first draining the fuel tank because of the hazard of leaking fuel. The tool shown in that patent engages the mower blade between a pair of stop pins. It could not be used effectively in the limited visibility and accessibility conditions under a riding mower. The tool could fall off because of the open space between the stop pins.

U.S. Pat. No. 4,882,960 (Kugler) is for a device that fits over the blade and requires sufficient clearance between the blade and the mower deck for installation. That device relies upon a threaded locking mechanism to prevent the blade from rotating. That device is also intended only for single-blade mowing decks. This device would likely require removing built-up grass and debris from the inside of the mower deck to provide sufficient clamping force.

U.S. Pat. No. 4,956,905 (Davidson) issued Sep. 18, 1990 is for a tool which requires the user to use one hand to control the tool and the other hand to utilize the wrench for removal or installation of the blade. Blades typically require substantially more force to remove than to install and riding mower blades can require 120 pounds of torque to install. This device, then, requires the user to exert 120 pounds or more force in one direction with the tool while exerting 120 pounds or more force in the opposite direction with the wrench. The operator will also not have a free hand to stabilize the wrench on the blade retaining nut or bolt. This device requires significant raw material and significant fabrication likely rendering it cost-prohibitive to potential users.

U.S. Pat. No. 6,272,724 (Sterling et al.) issued on Aug. 14, 2001 is for a tool similar to U.S. Pat. No. 4,956,905 (above) which requires the user to use one hand to control the tool and the other hand to utilize the wrench for removal or installation of the blade. Blades typically require substantially more force to remove than to install and riding mower blades can require 120 pounds of torque to install. This device, then, requires the user to exert 120 pounds or more force in one direction with the tool while exerting 120 pounds or more force in the opposite direction with the wrench. The operator will also not have a free hand to stabilize the wrench on the blade retaining bolt. This device is apparently designed for single-blade mowing decks only.

U.S. Pat. No. 6,276,039 (Barnes) issued on Aug. 21, 2001 is for a clamping tool to block blade movement. It relies upon friction against the side of the deck and because of the configuration of the clamping plier-like device would require that a single-blade mower deck be turned on its side for sufficient room to install the device. Further, the required clamping force could de-form the thin gauge stamped steel mower deck found on many low-cost mowers. For a riding mower, it would require that the mower be elevated to provide sufficient room to install the device. This device would likely require removing built-up grass and debris from the inside of the mower deck to provide sufficient clamping force. This device requires significant raw material and significant fabrication likely rendering it cost-prohibitive to potential users.

U.S. Pat. No. 6,715,194 (Sterling et al.) issued on Apr. 6, 2004 is for a tool similar to U.S. Pat. No. 6,272,724 (above) which requires the user to use one hand to control the tool and the other hand to utilize the wrench for removal or installation of the blade. Blades typically require substantially more force to remove than to install and riding mower blades can require 120 pounds of torque to install. This device, then, requires the user to exert 120 pounds or more force in one direction with the tool while exerting 120 pounds or more force in the opposite direction with the wrench. The operator will also not have a free hand to stabilize the wrench on the blade retaining bolt. This device requires significant raw material and significant fabrication likely rendering it cost-prohibitive to potential users. This device is apparently designed for single-blade mowing decks only.

U.S. Pat. No. 6,925,787 (Bernston) issued on Aug. 9, 2005 is in some ways similar to U.S. Pat. No. 4,882,960 (above) and U.S. Pat. No. 6,928,801 (below) and is for a device that relies upon the friction of a threaded locking mechanism to prevent the blade from rotating. That device apparently is intended only for single-blade mower decks. Current mowers typically have an extra lip at the bottom which would preclude this device from working. Further, it would not work on most fabricated metal decks (as opposed to stamped decks) which are typically employed by manufacturers of commercial quality mowers. This device would likely require removing built-up grass and debris from the inside of the mower deck to provide sufficient clamping force.

U.S. Pat. No. 6,928,801 (Papproth) issued on Aug. 16, 2005 is in some ways similar to U.S. Pat. No. 4,882,960 (above) and is for a device that relies upon the friction of a threaded locking mechanism to prevent the blade from rotating. That device apparently is intended only for single-blade mower decks. This device would likely require removing built-up grass and debris from the inside of the mower deck to provide sufficient clamping force.

U.S. Pat. No. 8,209,837 (Renshaw) issued on Jul. 2, 2012 which requires the user to attach the device to the blade and mower deck. That device apparently is intended to restrict movement of a single-blade by binding the device using the side of the mowers deck. This device would likely cause damage to the mower deck in order to provide sufficient stopping force to retain the blades due to the high torque requirements.

Other tools for working on lawn mower blades can be seen in the Greenquist U.S. Pat. No. 4,736,544, for a blade holder for sharpening lawn mower blades in which the blade is sharpened while still attached to the mower and in the Wanie U.S. Pat. No. 5,865,018 for a cutter blade removal tool which slips onto the end of the blade and protrudes into the discharge chute of the cowling (and by design would be incapable of being used in a mulching mower deck), the Tyler U.S. Pat. No. 7,152,326 which is a device for manually holding a blade (and by design would be incapable of being used in a mulching mower deck). The Williams U.S. Pat. No. 6,634,161 is for a specialized blade rather than a device which will work with existing mower blades.

### OBJECTS OF THE INVENTION

While all of the above devices may fulfill their respective particular objectives, they all have limitations ranging from limited application to difficulty to use to expensive fabrication or even damage to the mower deck. The subject device is therefore unique in that it:

will work on any mower deck containing two or more blades;

will work on mulching mower decks;

does not clamp or bind to the mower deck.

does not require the time and effort to elevate riding or commercial mowers;

eliminates the expense of lifts or ramps to elevate riding or commercial mowers;

does not rely on the ability of a locking device to provide sufficient friction to perform;

does not require the removal of built-up grass clippings and other debris prior to use;

does not rely on the need to jam the blade against a flat area or discharge chute;

does not rely on the user to hold blade stop device with one hand and wrench with other hand;

enables user to employ both hands on wrench: one to hold wrench and the other to stabilize wrench; and

can be fabricated in multiple fashions reducing fabrication cost. Other devices cited above require multiple fabrication steps and multiple parts whereas the subject could possibly be fabricated in as little as one process with stamping or molding manufacturing techniques.

### SUMMARY OF THE INVENTION

Accordingly, the need for a device to safely stop the rotation of a rotary mower blade during removal and installation has existed since the rotary mower was invented. Several advantages of this invention are as follows:

to provide a device that allows a safer procedure than the current available devices for the removal and installation of rotary mower blades;

to provide a device for said procedure that novices can easily use;

to provide a device that is fast enough and easy enough for said procedures that professionals will use them;

to provide a device that requires no adjustment to accommodate multiple blade widths and lengths;

to provide a device for said procedure that is inexpensive to manufacture;

to provide a device that secures mower blades in a manner that the manufacturer's torque specification on the retainer bolt or nut may be accurately obtained;

to provide a device that does not rely on the mower deck;

to provide a device that does not damage the mower deck;

to provide a device that does not extend outside of the mower deck;

Still further objects and advantages will become apparent from the drawings and descriptions.

### DETAILED DESCRIPTION OF DRAWINGS

In the drawings, corresponding numbers represent the same item or closely related items.

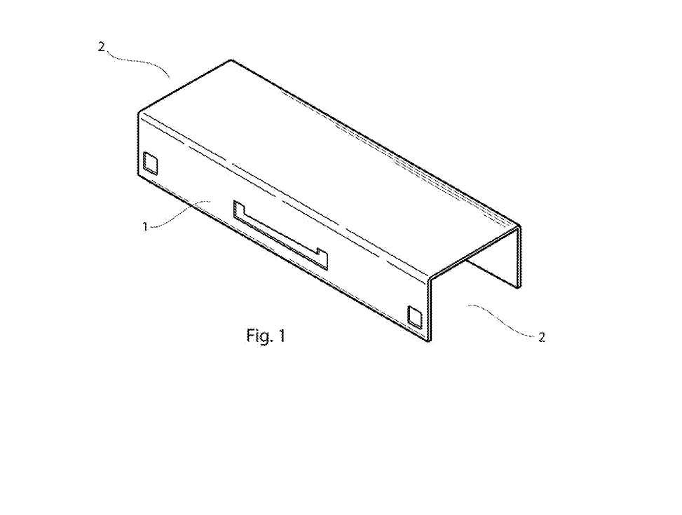

FIG. 1 shows the perspective view of the inventive device in which (1) shows the shape to be rectangular. (2) shows the area for receiving the blades to restrict the blades rotation by lodging against two blades at the same time, creating a bind on both blades.

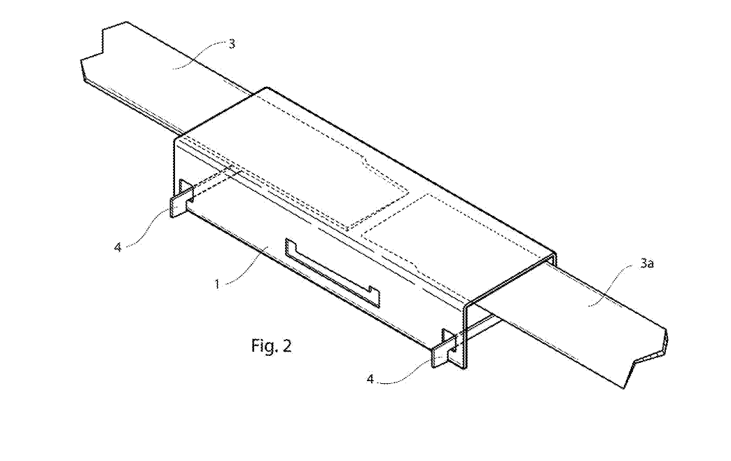

FIG. 2 shows the inventive device (1) with the first blade (3) and second blade (3a) inserted, retained by the optional pins (4). The device is located on top of the opposing blades.

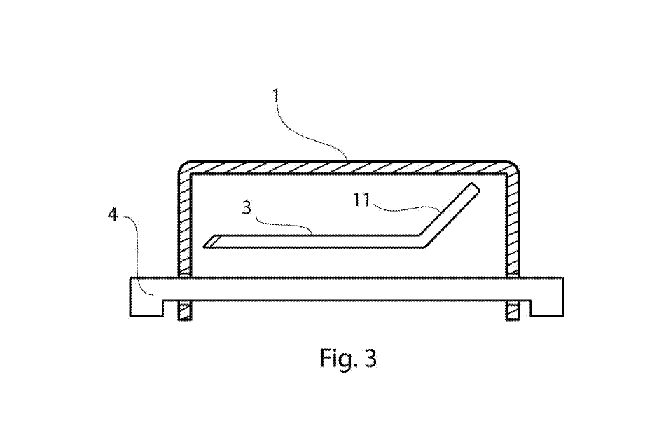

FIG. 3 shows the cut end view of the device (1) with an end view of the blade (3) inserted. The optional retaining pin (4) is also shown. The cut end view also demonstrates the ability to allow a blade (3) with a grass lifting wing (11) to securely sit within of the device (1).

FIG. 4 shows the underside of a typical multi-blade mower deck (5) and the device (1) with the first blade (3) and second blade (3a) inserted and restrained by the device (1). The optional retaining pins (4) are also shown installed through the device (1). A wrench (6) applies a tightening or loosening force to the blades bolt (7) which presses the first blade (3) and second blade (3a) into a restrictive bind against the device (1). The device (1) will be moved to sit on top of the second blade (3a) and third blade (3b) to remove the third blade (3b), which is not shown in the drawing but would look exactly as shown on the first blade (3) and the second blade (3a).

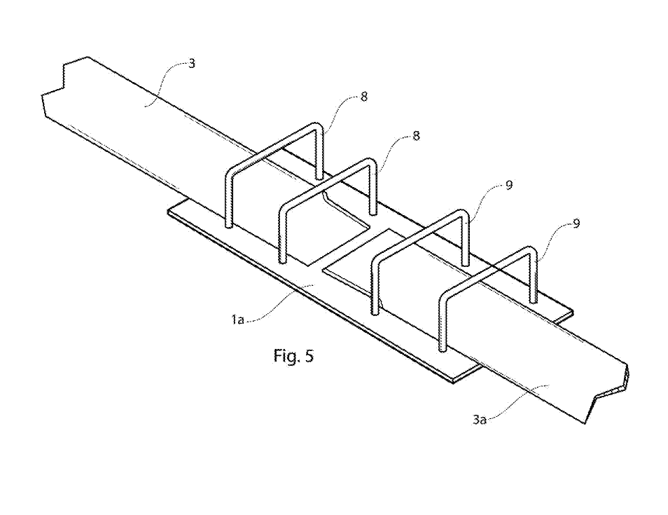

FIG. 5 shows an alternate embodiment of the device (1a) which is also a binding device. Loop retainers 1 (8) are inserted over first blade (3) and loop retainers 2 (9) are inserted over the second blade (3a). The restriction would be caused when applying a force to the blades bolts as previously explained. This embodiment can be constructed by casting, or by loops welded to a plate, or by loops bolted to a plate (for possible final assembly by the purchaser thus minimizing fabrication costs), or by stamping from a metal sheet.

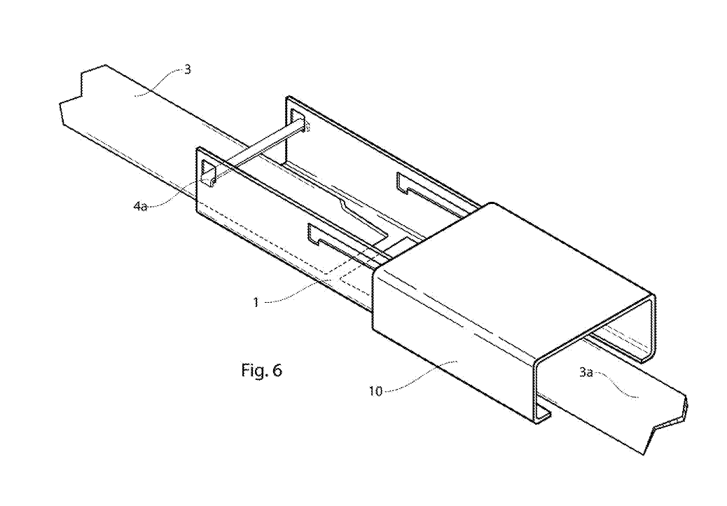

FIG. 6 shows an upside down, bottom perspective view of alternate embodiments of the optional retainer pins in the form of a lip retainer (10). FIG. 6 also shows a second alternate embodiment of the optional retainer pins (4a) with the retainer pin bent instead of a straight flat design. Both forms of alternate embodiments are for keeping the first blade (3) and second blade (3a) safely inside the device (1).

### DRAWINGS—REFERENCE NUMERALS

1 Device
1a Device Alternate
2 Area for Receiving Blade
3 First Blade
3a Second Blade
3b Third Blade
4 Optional Retaining Pin
4a Optional Retaining Pin Alternate
5 Underside View of Mower Deck
6 Wrench
7 Blade Bolt
8 Loop Retainers 1
9 Loop Retainers 2
10 Lip Retainer Alternate
11 Grass Lifting Wing on Blade

### DETAILED DESCRIPTION OF THE PREFERRED EMBODIMENTS

This device is constructed of steel or aluminum or composite or any other material sufficiently strong. It can be constructed of one piece of material formed by stamping bending or any similar method. It can also be constructed of pre-formed rectangular tubing with one side removed. It can also be constructed of multiple angles cut to size and attached together such as by welding. It can also be constructed by casting in a mold. It can be retained on the blades solely by gravity. Alternately, it can be retained on the blades with any of a number of pinning devices ranging from toggle pins to bolts to bolts and nuts to a pin with retaining clip. For embodiments utilizing the optional pins the device may have holes drilled, molded or punched completely through said tubing to allow a pin or shaft (4) (FIG. 2) to be inserted allowing it to serve as a retainer. For embodiments not utilizing a retainer (the device would be hand held) an optional lip (10) (FIG. 6) could be employed or the self-retaining embodiment (FIG. 5) could be utilized.

The device can be manufactured of any material so far as it is strong enough to withstand the repeated torque of wrenches and cheater bars.

### Operation

The manner of using this device is to first follow the manufacturer's recommendations (such as remove spark plug wire) before trying to remove the mowers first blade (3) and second blade (3a). The device must be used on mowers with two or more blades. At this point, the device (I) or (1a) would be placed over the mowers first blade (3) and second blade (3a) by sitting the device on top and over said blades allowing the device to restrict both blades. A retaining pin (4) or retaining pin alternate (4a) could be installed at this point or the tool could be held in place by gravity alone. The tool can also be held down by hand is so desired. Now the blades can be loosened by first rotating it until the device is solidly binding both blades together with the torque applied from a wrench (6) while turning the blade bolt (7). At this time as much torque as needed may be applied to loosen or tighten the blades retaining nut or bolt (7).

To re-install blades, simply turn said blade retaining nut or bolt (7) with the device (1) installed over said first blade (3) and said second blade (3a) in the opposite direction as it was in taking it off. Allow device to again rotate slowly to properly bind the said first blade (3) and said second blade (3a) together. Now the recommended torque may be applied to tighten blade retaining nut or bolt (7) with a wrench (6).

### CONCLUSIONS, RAMIFICATIONS AND SCOPE

Thus the reader will see that at least one embodiment of the device provides an easier-to-manufacture product that can be used on almost any type of rotary mower deck containing two or more blades allowing persons of almost any skill level to safely remove and reinstall mower blades to manufacturer recommended torque levels.

While my above description contains many specificities, these should not be construed as limitations on the scope, but rather as an exemplification of several embodiments thereof. Many other variations are possible. For example, a device could be constructed utilizing U-bolts to retain the blades. Another example, a device could be constructed of 2 short pieces of tubing bound by a chain to retain the blades and cause the said binding effect. Accordingly, the scope should be determined not by the embodiments illustrated, but by the appended claims and their legal equivalents.

1. A tool for locking and removing of the rotary blades of a power lawn mower having a standard deck said tool needing no movable adjustment parts to install on said power lawn mower and being comprised of:
1. A one piece member consisting of
2. A first flat surface having a front, back and two sides upon which two blades are held,
3. Second and third flat surfaces integral and perpendicular to said sides of said first flat surface for retaining said blades from rotation,
4. Said second and third flat surfaces are located on sides of said blades having said first surface resting against said blades located on interior of said deck when said tool is installed on said mower,
5. All said surfaces are located on the interior of said deck so that when said second and third flat surfaces engage said blades are locked in place so that the removal or installation of said blades can be accomplished.
